(19) United States
(12) Patent Application Publication
(10) Pub. No.: US 2010/0037258 A1
(43) Pub. Date: Feb. 11, 2010

(54) MOBILE BROADCASTING SYSTEM AND METHOD FOR ENHANCING MOBILE BROADCASTING SERVICES WITH RICH MEDIA INCLUDING AN ENHANCED SERVICE GUIDE

(75) Inventors: Suresh Chitturi, Plano, TX (US); Gaelle Martin-Cocher, Toronto (CA)

Correspondence Address: Research in Motion Corp/SLW;Attn: Glenda Wolfe, Building 6, Brazos East, Suite 100, 5000 Riverside Drive, Irving, TX, 75039, US

(73) Assignee: Research In Motion Limited, Waterloo (CA)

(21) Appl. No.: 12/187,682

(22) Filed: Aug. 7, 2008

(51) Int. Cl. H04N 5/445

(52) U.S. Cl. 725/39; 725/105

(57) ABSTRACT

Embodiments of a mobile broadcasting system and method for enhancing mobile broadcasting services with rich media are described herein. In some embodiments, a rich media element is included as part of a terminal capability requirement element of an access fragment of a service guide. The rich media element indicates capabilities to access and render associated rich media content. A rich media element may also be included in a preview data fragment of the service guide to indicate how to obtain a rich media clip to enable a user to preview a service or rich media content in a rich media format.

### TECHNICAL FIELD

Some embodiments pertain to mobile broadcasting and mobile broadcasting services. Some embodiments pertain to enhancing mobile broadcasting services with rich media content.

### BACKGROUND

Mobile broadcasting and mobile broadcasting services allow a user to watch television on a mobile device and conventionally have been limited to basic audio and video broadcasting. These mobile conventional broadcasting services have had limited functionality and have not been able to provide either rich service interactivity or rich media content. In other words, current broadcast solutions do not offer an in-band service level and interactive content as they are primarily based on basic audio and video capabilities. Rich media technologies, on the other hand, offer much needed interactivity that can tremendously enhance the user's experience with accurate synchronization of multiple media types including graphics, audio, video, images and text. In addition, rich media technologies also offer a rich set of animation and interaction functionalities not available in mobile broadcasting services.

Thus, there are general needs for mobile broadcasting systems and methods for enhancing mobile broadcasting services with rich media.

### BRIEF DESCRIPTION OF THE DRAWINGS

FIG. 1 illustrates a mobile broadcasting system in accordance with some embodiments;

FIG. 2 illustrates some example service guide fragments in accordance with some embodiments;

FIG. 3 graphically illustrates an access fragment in accordance with some embodiments;

FIG. 4 graphically illustrates a preview data fragment in accordance with some embodiments; and

FIG. 5 graphically illustrates the format of a notification message in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Examples merely typify possible variations. Individual components and functions are optional unless explicitly required, and the sequence of operations may vary. Portions and features of some embodiments may be included in, or substituted for those of other embodiments. Embodiments set forth in the claims encompass all available equivalents of those claims.

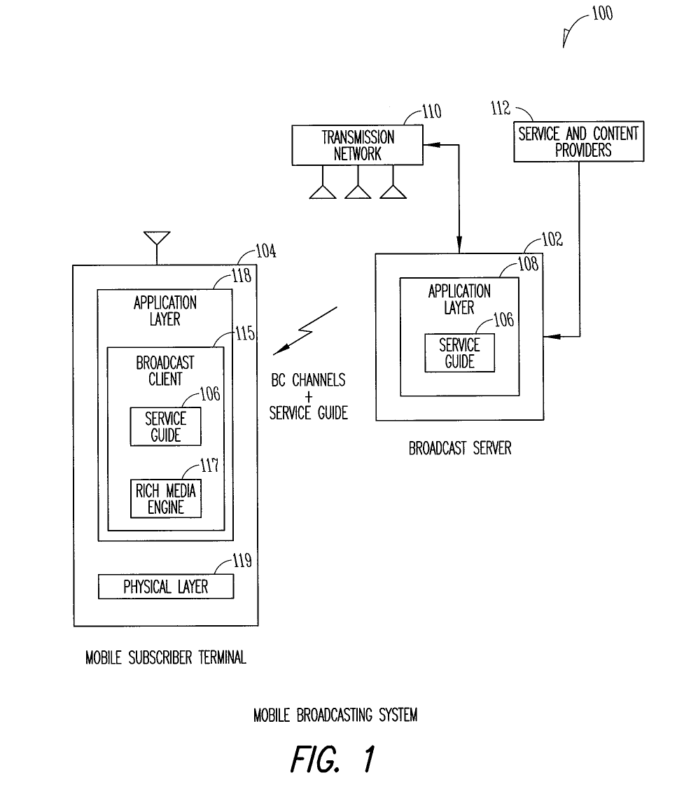

FIG. 1 illustrates a mobile broadcasting system in accordance with some embodiments. Mobile broadcasting system 100 includes broadcast server 102, one or more mobile subscriber terminals, such as mobile subscriber terminal 104, and transmission network 110. Broadcast server 102 provides content including a service guide for transmission to the mobile subscriber terminals through transmission network 110. Transmission network 110 may include terrestrial transmission networks as well as satellite-based transmission networks. Broadcast content as well as services may be provided by one or more service and content providers 112.

In accordance with some embodiments, broadcast server 102 is a rich media-based broadcast server that comprises application layer 108 configured to generate and/or provide service guide 106. Service guide 106 may include, among other things, an indication of the capabilities for mobile subscriber terminal 104 to access and render rich media content. Service guide 106 may also include an indication of how to preview an interactive service in a rich media format or to preview rich media content in a rich media format. In some embodiments, service guide 106 may include an element to provide an entry point to an interactive media document with rich media content embedded therein to provide a rich service level interaction. These embodiments are discussed in more detail below.

Mobile subscriber terminal 104 is configured to receive service guide 106 as well as broadcast channels from broadcast server 102. In accordance with some embodiments, mobile subscriber terminal 104 may include physical layer 119 to transmit and receive signals from transmission network 110, and application layer 118 configured to implement one or more applications running thereon. Application layer 118 may include, among other things, broadcast client 115 to store service guide 106 after delivery by broadcast server 102 for use in receiving and displaying content of the broadcast channels. In accordance with some embodiments, broadcast client 115 may also include rich media engine 117 configured to access service guide 106, and render and/or display rich media content received from broadcast server 102.

In accordance with embodiments, the indication of the capabilities provided in service guide 106 may indicate the capabilities for rich media engine 117 to render the rich media content. In some embodiments, broadcast server 102 may be configured to include, as part of service guide 106, a notification message to indicate updates to service guide 106. The notification message may include rich media as a media type. These embodiments are also discussed in more detail below.

In some embodiments, mobile subscriber terminal 104 may be configured to access and render rich media content in mobile broadcasting system 100, and physical layer 119 may receive radio-frequency (RF) signals from broadcast server 102 through transmission network 110. The RF signals may include service guide 106, among other things. In these embodiments, rich media engine 117 within application layer 118 may access and render rich media content indicated by service guide 106. Service guide 106 may include an indication of the capabilities for rich media engine 117 to access and render the rich media content. Service guide 106 may also include information for obtaining and previewing a service or content in a rich media format.

Mobile broadcasting system 100 may be a mobile broadcasting system that operates in accordance with one or more mobile broadcasting techniques and/or specifications, such as the Open Mobile Alliance (OMA) Mobile Broadcast Services (BCAST) specifications, the Digital Video Broadcasting (DVB) specification for terrestrial (DVB-T), satellite (DVB-S), hybrid-satellite (DVB-H) and satellite-handheld (DVB-SH) of the European Telecommunications Standards Institution (ETSI), and/or the MediaFlo specifications of the Telecommunications Industry Association (TIA), although the scope of the embodiments is not limited to any of these techniques and/or specifications.

In some embodiments, mobile broadcasting system 100 may be part of a WiMax or a 3^{rd} Generation Partnership Project (3GPP)-LTE (4G) communication system configured to provide mobile broadcasting services in accordance with the IEEE 802.16(e) or the 3GPP-LTE communication standards. In these embodiments, transmission network 110 may use orthogonal frequency division multiple access (OFDMA) as an access technique and for broadcasting, although the scope of the embodiments is not limited in this respect.

Although mobile broadcasting system 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), radio-frequency integrated circuits (RFICs) and combinations of various hardware and logic for performing at least the functions described herein. In some embodiments, the functional elements of mobile broadcasting system 100 may refer to one or more processes operating on one or more processing elements. For example, application layer 108 and application layer 118 may include one or more processing elements configured with software to implement the functions described herein.

Service guide 106 enables service and content providers 112 to describe the services and content that are made available or offered for subscription or purchase by a user of mobile subscriber terminal 104. A service guide, as used herein, may be any type of program guide. These mobile broadcast services, including content, may be provided over a broadcast channel or an interaction channel. Service guide 106 may also describe how to access the services. From the user's perspective, service guide 106 serves as an entry point to discover currently available and/or scheduled services and content. Service guide 106 may also provide an entry point for interactive services. Service guide 106 also models services, schedules, content, related purchase and provisioning data, and access and interactivity data in terms of service guide fragments used for entry. These service guide fragments may be Extensible Markup Language (XML) fragments, although the scope of the embodiments is not limited in this respect.

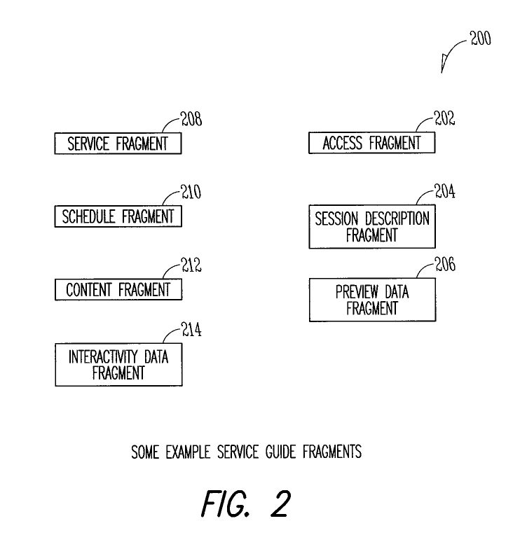

FIG. 2 graphically illustrates some example service guide fragments in accordance with some embodiments. Service guide fragments 200 may be part of service guide 106 (FIG. 1). In accordance with embodiments, service guide fragments 200 may be configured to include an indication of the capabilities for mobile subscriber terminal 104 (FIG. 1) to access and render rich media content. Service guide fragments 200 may also include an indication of how to preview an interactive service in a rich media format or an indication to preview rich media content in a rich media format. In some embodiments, service guide fragments 200 may be configured to include an element to provide an entry point to an interactive media document with rich media content embedded therein to provide a rich service level interaction.

In some embodiments, service guide fragments 200 may include access fragment 202, session description fragment 204, preview data fragment 206, service fragment 208, schedule fragment 210, content fragment 212 and interactivity data fragment 214. Service guide fragments 200 may also include various purchasing and provisioning related fragments that are not illustrated. The functional connections between the fragments are not illustrated. Although the example of service guide fragments 200 illustrated in FIG. 2 represents service guide fragments similar to service guide fragments of the OMA BCAST specifications, the scope of the embodiments is not limited in this respect.

Service fragment 208 describes, at an aggregated level, the content items which comprise a broadcast service. The service may be delivered to a user using multiple means of access, such as through a broadcast channel and an interactive channel. As part of a service guide, service fragment 208 forms a central hub referenced by the other fragments including access fragment 202, schedule fragment 210, content fragment 212 and a purchase item fragments (not shown). Together with the associated fragments, mobile subscriber terminal 104 (FIG. 1) may determine the details associated with the service at any point of time.

Schedule fragment 210 defines the timeframes in which associated content items are available for streaming, downloading and/or rendering. This fragment references service fragment 208. Schedule fragment 210 may also defines the valid distribution and/or presentation timeframe of those content items belonging to the service, or the valid distribution timeframe and the automatic activation time of interactivity media documents associated with the service.

Content fragment 212 provides a detailed description of a specific content item. Content fragment 212 may define the type, the description and the language of the content, among other things. Content fragment 212 may be referenced by schedule fragment 210 and may reference preview data fragment 206 or service fragment 208.

Access fragment 202 describes how the service may be accessed during the lifespan of the service. Access fragment 202 includes or references session description information and indicates the delivery method. One or more access fragment 202 may reference service fragment 208 offering alternative ways for accessing or interacting with the associated service. For mobile subscriber terminal 104 (FIG. 1), access fragment 202 provides information on the capabilities for mobile subscriber terminal 104 (FIG. 1) to receive and render the service. Access fragment 202 provides session description parameters either in the form of inline text, or through a pointer in the form of a Uniform Resource Identifier (URI) to a separate session description. Session description information may be delivered over either the broadcast channel or the interaction channel. In accordance with some OMA embodiments, a rich media element may be included as part of a terminal capability requirement element of access fragment 202 to indicate the capabilities for rich media engine 117 (FIG. 1) to access and render the rich media content. These embodiments are described in more detail below.

Session description fragment 204 provides the session information for access to a service or content item. Session description information may be provided using either syntax of a session description protocol (SDP) in text format, or through a 3GPP Multimedia Broadcast Multicast Service (MBMS) user service bundle description. Auxiliary description information may be provided in XML format and may include an associated delivery description.

Preview data fragment 206 includes information that is used by mobile subscriber terminal 104 (FIG. 1) to present the service or content outline to users, so that the users can have a general idea of what the service or content is about. Preview data fragment 206 may include simple texts, static images (for example, logo), short video clips, or even reference to another service which could be a low bit rate version for the main service. Service fragment 208, content fragment 212, access fragment 202 and schedule fragment 210 may reference preview data fragment 206. In accordance with some embodiments, a rich media element may also be included as part of preview data fragment 206 to indicate how to obtain the rich media clip to enable the preview in the rich media format. These embodiments are described in more detail below.

Interactivity data fragment 214 may include information used by mobile subscriber terminal 104 (FIG. 1) to offer interactive services associated with the broadcast content. These interactive services may enable users to interact with the broadcast content (e.g., vote during a broadcast or obtain content related to the broadcast content). Interactivity data fragment 214 may point to one or more interactivity media documents. Interactivity data fragment 214 may reference the service fragment 208 and content fragment 212, and may be referenced by the schedule fragment 210.

In accordance with some embodiments, interactivity data fragment 214 may provide a point of entry to an interactivity media document. The contents of an interactivity media document may trigger mobile subscriber terminal 104 (FIG. 1) to render the details of an interactivity media object's message onto a graphical user interface (GUI) which may prompt the user of the terminal to react. In accordance with some embodiments, interactivity data fragment 214 may provide an entry point to an interactive media document having rich media content embedded therein to provide rich service level interaction. The interactive media document may comprise an initial scene in a media object set with an associated Multipurpose Internet Mail Extensions (MIME) type and location. The interactive media document may alternatively comprise an initial scene followed by a set of scene updates packaged in a scene command group. The interactive media document may alternatively comprise a file that includes a scene and scene updates in either 3GPP dynamic and interactive multimedia scene (DIMS) units or in an MPEG Simple Aggregation Format (SAF). Other packaging of scene updates or scene commands or stream of scenes may also be used. In accordance with some embodiments, a rich media scene may be inserted into the interactivity media document, examples of which are illustrated in the following table:

| Media | | | |
|---|---|---|---|
| Object | | | |
| Group | Media Object Set | Content Type | Content Location |
| Example 1 | Initial Scene | application/richmedia+xml | FLUTE or any URI |
| Example 2 | Initial Scene | application/richmedia+xml | FLUTE or any URI |
| | SceneCommandGroup1 | application/richmediacommand+xml | FLUTE or any URI |
| | SceneCommandGroup2 | application/richmediacommand+xml | FLUTE or any URI |
| | SceneCommandGroupn | application/richmediacommand+xml | FLUTE or any URI |
| Example 3 | Scene + Updates | Video/3GPP | FLUTE or any URI |
| | packaged in a file (e.g., | | |
| | 3GPP DIMS or MPEG | | |
| | SAF) | | |

Example 1 illustrates the use of an initial scene in the media object set with the associated MIME type and location. The location of the initial scene may be the location of the file delivered via the File Delivery over Unidirectional Transport (FLUTE) protocol (i.e., with a reference to the location in the File Delivery Table (FDT) or an arbitrary URI). Example 2 illustrates how an interactivity document may be made up with an initial scene followed by a set of scene updates packaged in a scene command group, which may be defined by the OMA RME specification. Example 3 illustrates the inclusion of rich media content using a 3GPP file which includes the scene and scene updates, which may be referred to as Dynamic and Interactive Multimedia Scene (DIMS) units.

In some DVB embodiments, the service guide fragments may include an acquisition fragment. In these DVB embodiments, a rich media element may be included as part of a component characteristic of the acquisition fragment to indicate the capabilities for rich media engine 117 (FIG. 1) to access and render the rich media content. In these DVB embodiments, service guide 106 may be referred to as an electronic service guide (ESG), and the service guide fragments may be generated in accordance with the DVB ESG specification, although the scope of these embodiments is not limited in this respect. In these embodiments, the acquisition fragment may correspond to an acquisition fragment of the DVB ESG specification.

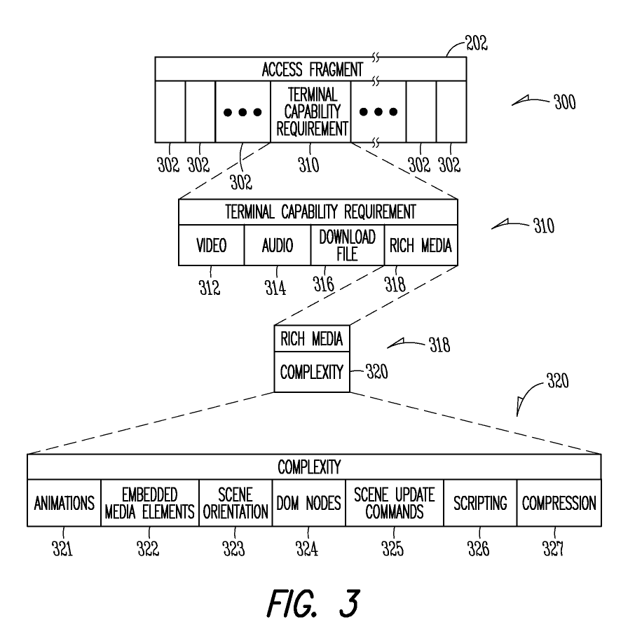

FIG. 3 graphically illustrates an access fragment in accordance with some embodiments. Access fragment 300 may correspond to access fragment 202 (FIG. 2). Access fragment 300 may include a plurality of elements 302 that may, among other things, describe how the service may be accessed. For example, elements 302 of access fragment 300 may include an access type element, a key management system element, an encryption type element, a service reference element, a schedule reference element, terminal capability requirement element 310, a bandwidth requirement element, a service class element, a preview data reference element, a notification reception element, and a private extension element. Application layer 108 (FIG. 1) may be configured to generate access fragment 300.

Terminal capability requirement element 310 includes video element 312, audio element 314 and download file element 316. Video element 312 may describe the video codec capability related requirements, audio element 314 may describe the audio codec capability, and download file element 316 may describe the capability for a terminal to download files. In accordance with some embodiments, terminal capability requirement element 310 may also include rich media element 318 to indicate the capabilities for a mobile subscriber terminal to access and render the rich media content. For example, the capabilities indicated by rich media element 318 may be the capabilities that rich media engine 117 (FIG. 1) of mobile subscriber terminal 104 (FIG. 1) would need to access and render the rich media content.

In these embodiments, rich media element 318 may be a sub-element of terminal capability requirement element 310. In these embodiments, rich media element 318 may indicate a number of animations, a number of embedded media elements, and a number of document object model (DOM) nodes to render a rich media scene. In XML DOM, each node is an object. In some embodiments, rich media element 318 may also indicate whether scene orientation management, scene update commands, scripts, and compression/encoding are to be used by the rich media engine 117 to render the rich media scene.

In some embodiments, access fragment 300 may be associated with one of a plurality of broadcast channels, and rich media element 318 may indicate the capabilities for rich media engine 117 (FIG. 1) to access and render (e.g., properly consume display and/or play) rich media content associated with a broadcast channel.

In some embodiments, rich media element 318 may include complexity element 320 to indicate the complexity associated with the rich media content. In these embodiments, complexity element 320 may include one or more of animations element 321, embedded media elements element 322, scene orientation element 323 and/or DOM nodes element 324. Animations element 321 may indicate a number of animations in the rich media content. Embedded media elements element 322 may indicate a number of embedded media elements (e.g., audio or video streams) in the rich media content. Scene orientation element 323 may indicate whether the rich media content uses scene orientation management. DOM nodes element 324 may indicate a number of document object model nodes to render the rich media content.

In some embodiments, complexity element 320 may also include one or more of scene update commands element 325, scripting element 326, and/or compression element 327. Scene update commands element 325 may indicate whether the rich media content includes scene update commands to modify the rich media content. Scripting element 326 may indicate whether the rich media content includes scripts that modify the rich media content. Compression element 327 may indicate whether the rich media content is delivered compressed or encoded, or whether the rich media content is delivered in an XML or an original raw format.

In some embodiments, rich media element 318 may be included in access fragment 202 when the complexity indicated by the MIME type parameters in the SDP differs from the actual complexity. In some embodiments, animations element 321 may include an attribute to indicate the maximum number of animations in the rich media content. Embedded media elements element 322 may include an embedded video attribute to indicate a number of concurrently running embedded video elements in the rich media content. Embedded media elements element 322 may also include an embedded audio attribute to indicate a number of concurrently running embedded audio elements in the rich media content. DOM nodes element 324 may include an attribute to indicate the maximum number of active DOM nodes in the rich media content. Compression element 327 may include an encoding attribute to indicate the particular scheme to encode or compress the rich media content.

Rich media content, as used herein, may include, in addition to an audio-video broadcasted stream, at least some of animations, embedded media elements, scene orientation modes, and DOM nodes. Rich media content may comprise a scene and a set of scene updates, including features that are applied to the scene. For example, rich media content, in addition to a scene, may include scene-update commands, scripting and compression.

In some embodiments, an XML language, such as the Scalable Vector Graphics (SVG) language, may be used for the base content format for delivering rich media content when mobile broadcast system 100 operates in accordance with either the 3GPP DIMS specification or the OMA RME specification. In these embodiments, either the 3GPP DIMS of the OMA RME format may be used. SVG may be used for representing two-dimensional vector graphics and provided for scalability, interactivity, animations, and the ability to embed media such as raster images, in audio and video content. SVG-based rich media content may also be delivered by inclusion in other content formats, such as Synchronized Multimedia Integration Language (SMIL) and Compound Document Formats (CDFs). In some embodiments, W3C SVG Tiny 1.2 may be used as the rich media format. Other examples of rich media formats may include MPEG LASeR, W3C SVG, Adobe Flash™ and Microsoft Silverlight™, although the scope of the embodiments is not limited to any particular type of rich media format or any encoding of rich-media format.

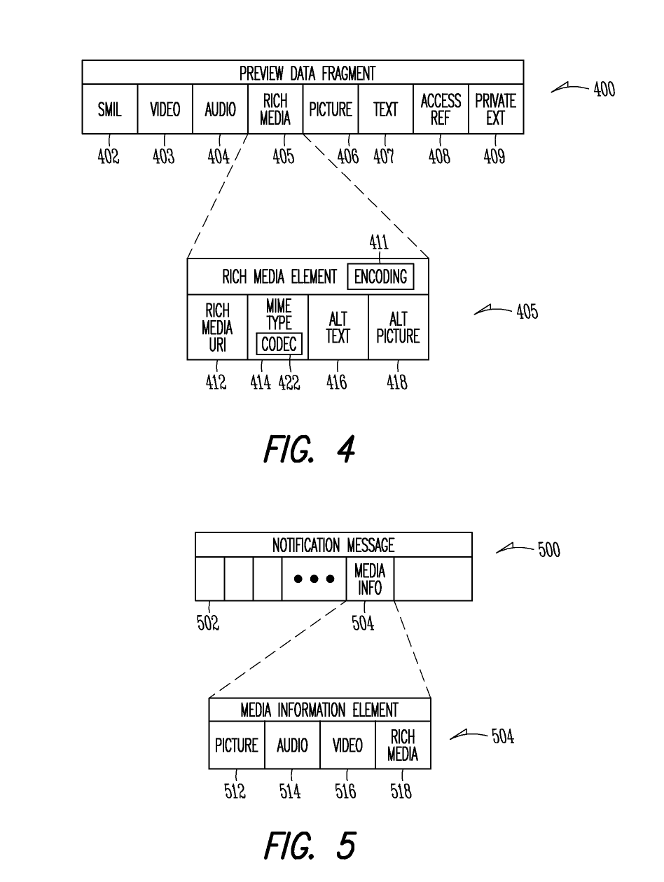

FIG. 4 graphically illustrates a preview data fragment in accordance with some embodiments. Preview data fragment 400 may correspond to preview data fragment 206 (FIG. 2). In accordance with some embodiments, preview data fragment 400 may include information referencing a rich media clip. In accordance with some embodiments, preview data fragment 400 may include SMIL element 402, video element 403, audio element 404, rich media element 405, picture element 406, text element 407, access reference element 408 and private extension element 409. Rich media element 405 may indicate a rich media URI referencing the rich media clip, a MIME media type of the rich media clip, alternative text to be displayed when the rich media clip is not available, and/or an alternative picture to be displayed when the rich media clip is not available. Application layer 108 (FIG. 1) may be configured to generate preview data fragment 400.

In some embodiments, rich media element 405 may include rich media URI element 412 referencing the rich media clip and MIME type element 414 indicating a MIME media type of the rich media clip. Rich media element 405 may also include alternative text element 416 indicating alternative text to be displayed either when the rich media clip is not available or cannot be played by mobile subscriber terminal 104 (FIG. 1). Rich media element 405 may also include alternate picture element 418 indicating an alternative picture to be displayed when the rich media clip is not available, cannot be played by the mobile subscriber terminal, or cannot be rendered by the mobile subscriber terminal. In some embodiments, rich media element 405 may include an alternate rich media scene.

In some embodiments, when Asynchronous Layered Coding (ALC) is used for delivery of the rich media clip, rich media URI element 412 may correspond to a content-location attribute in a file element in access fragment 202. When FLUTE is used for delivery of the rich media clip, rich media URI element 412 may correspond to a content location attribute in an FDT of the FLUTE session. When HTTP is used for delivery of the rich media clip, rich media URI element 412 may correspond to a request URI to be used in a request line of the HTTP request. When a Real Time Streaming Protocol (RTSP) is used for negotiation of the rich media clip delivery, rich media URI element 412 may correspond to a request-URI to be used in a request line of the RTSP request.

In some embodiments, MIME type element 414 may include codec attribute 422 to indicate the codec parameters associated with the MIME media type. In some embodiments, alternative text element 416 may provide alternate text in multiple languages. The language may be expressed in a built-in XML attribute.

In some embodiments, rich media element 405 of preview data fragment 400 may include encoding attribute 411 to indicate how the rich media data is embedded when the rich media data is not embedded into a character data (CDATA) section. In some embodiments, the encoding attribute 411 may be set to a specific MIME content transfer encoding scheme, such as Base 64 encoding, although the scope of the embodiments is not limited in this respect.

In some embodiments, access reference element 408 may include a usage attribute indicating that preview data files referenced by rich media URI element 412 are to be accessed from a file distribution session. In these embodiments, scheduling of the file distribution session may be signaled by a session description embedded in or referenced by an access fragment associated with preview data fragment 400. In these embodiments, access reference element 408 may indicate an ID of the access fragment specifying delivery of associated preview data via a broadcast channel during a file distribution session or a stream distribution session, although the scope of the embodiments is not limited in this respect. When the preview data files are not associated with a rich media clip, the usage attribute may indicate the preview data files referenced by a Video URI, Audio URI or Picture URI to be accessed from the file distribution session.

FIG. 5 graphically illustrates the format of a notification message in accordance with some embodiments. Notification message 500 may, among other things, indicate updates to service guide 106 (FIG. 1), updates to mobile subscriber terminal 104 (FIG. 1) or updates to the user, including updates to indicate rich media as a media type. Notification message 500 may include a plurality of elements 502. Elements 502 may include an ID Reference element, a title element, a description element, a presentation type element, an extension element, a session information element, media information element 504, a Service Guide Delivery Descriptors (SGDD) element, an SGDD reference element, a fragment ID element, an auxiliary data trigger element, and a private extension element. Application layer 108 (FIG. 1) may be configured to generate notification message 500.

In accordance with some embodiments, media information element 504 may include picture element 512, audio element 514, video element 516 and rich media element 518. Rich media element 518 may define how to obtain particular rich media content and a MIME type of the rich media content. In some embodiments, rich media element 518 includes a MIME type attribute to indicate the MIME type, a codec attribute to indicate codec parameters for the MIME type, and a rich media URI attribute to indicate a URI that references the associated rich media content.

In some embodiments, notification message 500 may be a BCAST notification message provided in accordance with the OMA BCAST specification, although the scope of the embodiments is not limited in this respect. In other embodiments, notification message 500 may be provided in accordance with one of the DVB specifications referenced above.

Some embodiments may be implemented in one or a combination of hardware, firmware and software. Embodiments may also be implemented as instructions stored on a computer-readable medium, which may be read and executed by at least one processor to perform the operations described herein. A computer-readable medium may include any mechanism for storing or transmitting information in a form readable by a machine (e.g., a computer). For example, a computer-readable medium may include read-only memory (ROM), random-access memory (RAM), magnetic disk storage media, optical storage media, flash-memory devices, and others. For example, application layer 108 and application layer 118 may include one or more processing elements configured with software to implement the functions and generate the various fragments and messages described herein.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method of enhancing mobile broadcast services with rich media content comprising including in a service guide at least one of:
an indication of capabilities for a mobile subscriber terminal to access and render rich media content; and
information for obtaining and previewing a service or content in a rich media format.

2. The method of claim 1, wherein the service guide comprises a plurality of service guide fragments for use as entry points,
wherein the service guide fragments include at least one of an access fragment and a preview data fragment,
wherein an access rich media element is included as part of a terminal capability requirement element of the access fragment to indicate the capabilities for a rich media engine of the mobile subscriber terminal to access and render the rich media content, and
wherein a preview data rich media element is included as part of the preview data fragment to include the information for obtaining and previewing a rich media clip in the rich media format.

3. The method of claim 2, wherein the service guide fragments are generated in accordance with an Open Mobile Alliance (OMA) Mobile Broadcast Services (BCAST) service guide specification, and
wherein the access fragment and the preview data fragment correspond to an access fragment and a preview data fragment of the service guide fragments of the OMA BCAST service guide specification.

4. The method of claim 1, wherein the service guide comprises a plurality of service guide fragments for use as entry points, the service guide fragments comprising an acquisition fragment, and
wherein an acquisition fragment rich media element is included as part of a component characteristic of the acquisition fragment to indicate capabilities for a rich media engine of the mobile subscriber terminal to access and render the rich media content.

5. The method of claim 4, wherein the service guide comprises an electronic service guide (ESG),
wherein the service guide fragments including the component characteristic are generated in accordance with a Digital Video Broadcasting (DVB) ESG specification, and
wherein the acquisition fragment corresponds to an acquisition fragment of the DVB ESG specification.

6. The method of claim 2, wherein the access fragment is associated with one of a plurality of broadcast channels, and the access rich media element indicates capabilities for the rich media engine to access and render rich media content associated with one of the broadcast channels, and
wherein the rich media content includes, in addition to an audio-video stream, at least some of animations, embedded media elements, scene orientation modes, and document object model (DOM) nodes.

7. The method of claim 6, wherein the access rich media element is a sub-element of the terminal capability requirement element, and
wherein the rich media element indicates:
a number of animations, a number of embedded media elements, and a
number of DOM nodes to render the rich media content; and
whether scene orientation management, scene update commands, scripts, and compression/encoding are to be used by the rich media engine to render the rich media content.

8. The method of claim 7, wherein the access rich media element includes a complexity element indicative of a complexity of the rich media content, and wherein the complexity element includes one or more of:
an animations element indicating a number of animations in the rich media content;
an embedded media elements element indicating a number of embedded media elements in the rich media content;
a scene orientation element indicating whether the rich media content uses scene orientation management; and
a DOM nodes element indicating a number of document object model (DOM) nodes to render the rich media content.

9. The method of claim 8, wherein the complexity element further includes one or more of:
a scene update commands element indicating whether the rich media content includes scene update commands to modify the rich media content;
a scripting element to indicate whether the rich media content includes scripts that modify the rich media content; and
a compression element to indicate whether the rich media content is delivered compressed or encoded, or whether the rich media content is delivered in an original format.

10. The method of claim 2, wherein the preview data rich media element indicates a rich media Uniform Resource Identifier (URI) referencing the rich media clip, a media type of the rich media clip, alternative text to be displayed when the rich media clip is not available, and an alternative picture to be displayed when the rich media clip is not available or cannot be rendered by the mobile subscriber terminal.

11. The method of claim 10, wherein the preview data rich media element includes at least one of:
a rich media Uniform Resource Identifier (URI) element referencing the rich media clip;
a Multipurpose Internet Mail Extensions (MIME) type element indicating a MIME media type of the rich media clip;
an alternative text element indicating alternative text to be displayed either when the rich media clip is not available or the rich media clip cannot be played by the mobile subscriber terminal; and
an alternate picture element indicating an alternative picture to be displayed when either the rich media clip is not available or the rich media clip cannot be displayed by the mobile subscriber terminal.

12. The method of claim 11, wherein the preview data rich media element includes an encoding attribute to indicate how the rich media data is embedded when the rich media data is not embedded into a character data (CDATA) section,
wherein the preview data fragment further includes an access reference element that includes a usage attribute indicating that preview data files referenced by the rich media URI element are to be accessed from a file distribution session, and
wherein scheduling of the file distribution session is signaled by a session description embedded in or referenced by an access fragment associated with the preview data fragment.

13. The method of claim 2, wherein the service guide further comprises an interactivity data fragment to provide an entry point to an interactive media document,
wherein rich media content is embedded within the interactive media document to provide rich service level interaction, and
wherein the interactive media document comprises one of:
an initial scene in a media object set with an associated Multipurpose Internet Mail Extensions (MIME) type and location,
an initial scene followed by a set of scene updates packaged in a scene command group; or
a file that includes a scene and scene updates.

14. The method of claim 1 further comprising providing a notification message to indicate updates to the service guide, the notification message including rich media as a media type,
wherein the notification message includes a notification message rich media element within a media information element, the notification message rich media element defining how to obtain particular rich media content and a Multipurpose Internet Mail Extensions (MIME) type of the rich media content.

15. The method of claim 14, wherein the notification message rich media element includes a MIME type attribute to indicate the MIME type, a codec attribute to indicate codec parameters for the MIME type, and a rich media Uniform Resource Identifier (URI) attribute to indicate a URI that references associated rich media content.

16. A mobile broadcasting system comprising:
a broadcast server; and
a mobile subscriber terminal comprising a rich media engine operating within a broadcast client configured to access and render rich media content received from the broadcast server,
wherein the broadcast server is configured to include, as part of a service guide at least one of an indication of capabilities for the mobile subscriber terminal to access and render the rich media content and information for obtaining and previewing a service or content in a rich media format.

17. The system of claim 16, wherein the service guide comprises a plurality of service guide fragments for use as entry points,
wherein the service guide fragments include at least one of an access fragment and a preview data fragment,
wherein an access rich media element is included as part of a terminal capability requirement element of the access fragment to indicate the capabilities for a rich media engine of the mobile subscriber terminal to access and render the rich media content, and
wherein a preview data rich media element is included as part of the preview data fragment to include the information for obtaining and previewing a rich media clip in the rich media format.

18. The system of claim 17, wherein the access fragment is associated with one of a plurality of broadcast channels, and the access rich media element indicates capabilities for the rich media engine to access and render rich media content associated with the associated broadcast channel, and
wherein the rich media content includes, in addition to an audio-video stream, at least some of animations, embedded media elements, scene orientation modes, and document object model (DOM) nodes.

19. The system of claim 17, wherein the preview data rich media element indicates a rich media Uniform Resource Identifier (URI) referencing the rich media clip, a media type of the rich media clip, alternative text to be displayed when the rich media clip is not available, and an alternative picture to be displayed when the rich media clip is not available or cannot be rendered by the mobile subscriber terminal.

20. The system of claim 17, wherein the service guide further comprises an interactivity data fragment to provide an entry point to an interactive media document,
wherein rich media content is embedded within the interactive media document to provide rich service level interaction, and
wherein the interactive media document comprises one of:
an initial scene in a media object set with an associated Multipurpose Internet Mail Extensions (MIME) type and location,
an initial scene followed by a set of scene updates packaged in a scene command group; or
a file that includes a scene and scene updates.

21. The system of claim 16, wherein the broadcast server is further configured to provide a notification message to indicate updates to the service guide, the notification message including rich media as a media type,
wherein the notification message includes a notification message rich media element within a media information element, the notification message rich media element defining how to obtain particular rich media content and a Multipurpose Internet Mail Extensions (MIME) type of the rich media content.

22. A mobile subscriber terminal configured to access and render rich media content in a mobile broadcasting system, the mobile subscriber terminal comprising:
a physical layer to receive RF signals from a broadcast server of the mobile broadcasting system, the signals including a service guide; and
a rich media engine within an application layer to access and render rich media content indicated by the service guide,
wherein the service guide includes at least one of an indication of capabilities for the rich media engine to access and render the rich media content and includes information for obtaining and previewing a service or content in a rich media format.

23. The mobile subscriber terminal of claim 22, wherein the service guide comprises a plurality of service guide fragments for use as entry points,
wherein the service guide fragments include at least one of an access fragment and a preview data fragment,
wherein an access rich media element is included as part of a terminal capability requirement element of the access fragment to indicate the capabilities for a rich media engine of the mobile subscriber terminal to access and render the rich media content, and
wherein a preview data rich media element is included as part of the preview data fragment to include the information for obtaining and previewing a rich media clip in the rich media format.

24. The mobile subscriber terminal of claim 23, wherein the access fragment is associated with one of a plurality of broadcast channels, and the access rich media element indicates capabilities for the rich media engine to access and render rich media content associated with one of the broadcast channels, and
wherein the rich media content includes, in addition to an audio-video stream, at least some of animations, embedded media elements, scene orientation modes, and document object model (DOM) nodes.

25. The mobile subscriber terminal of claim 23, wherein the preview data rich media element indicates a rich media Uniform Resource Identifier (URI) referencing the rich media clip, a media type of the rich media clip, alternative text to be displayed when the rich media clip is not available, and an alternative picture to be displayed when the rich media clip is not available or cannot be rendered by the mobile subscriber terminal.

26. The mobile subscriber terminal of claim 23, wherein the service guide further comprises an interactivity data fragment to provide an entry point to an interactive media document,
wherein rich media content is embedded within the interactive media document to provide rich service level interaction, and
wherein the interactive media document comprises one of:
an initial scene in a media object set with an associated Multipurpose Internet Mail Extensions (MIME) type and location,
an initial scene followed by a set of scene updates packaged in a scene command group; or
a file that includes a scene and scene updates.

27. The mobile subscriber terminal of claim 22, wherein the mobile subscriber terminal is configured to receive a notification message from the broadcast server, the notification message to indicate updates to the service guide, the notification message including rich media as a media type, and
wherein the notification message includes a notification message rich media element within a media information element, the notification message rich media element defining how to obtain particular rich media content and a Multipurpose Internet Mail Extensions (MIME) type of the rich media content.

28. A computer-readable medium that stores instructions for execution by one or more processors perform operations to enhance mobile broadcast services with rich media, the operations comprising including within a service guide, at least one of:
an indication of capabilities for a mobile subscriber terminal to access and render rich media content; and
information for obtaining and previewing a service or content in a rich media format.

29. The computer-readable medium of claim 28, wherein the service guide comprises a plurality of service guide fragments for use as entry points,
wherein the service guide fragments include at least one of an access fragment and a preview data fragment,
wherein an access rich media element is included as part of a terminal capability requirement element of the access fragment to indicate the capabilities for a rich media engine of the mobile subscriber terminal to access and render the rich media content, and
wherein a preview data rich media element is included as part of the preview data fragment to include the information for obtaining and previewing a rich media clip in the rich media format.

30. The computer-readable medium of claim 29, wherein the instructions, when further implemented cause the one or more possessors to:
include an interactivity data fragment to provide an entry point to an interactive media document, wherein rich media content is embedded within the interactive media document to provide rich service level interaction; and
provide a notification message to indicate updates to the service guide, the notification message including rich media as a media type.

31. A method of enhancing mobile broadcast services with rich media content comprising:
including, as part of a terminal capability requirement element of an access fragment, an access rich media element that indicates capabilities for a rich media engine of a mobile subscriber terminal to access and render rich media content;
including, as part of a preview data fragment, a preview data rich media element that includes information for obtaining and previewing a rich media clip in the rich media format;
including an interactivity data fragment to provide an entry point to an interactive media document, wherein rich media content is embedded within the interactive media document to provide rich service level interaction; and
providing a notification message to indicate updates to a service guide, the notification message including rich media as a media type,
wherein the access fragment, the preview data fragment and the interactivity data fragment are fragments of the service guide comprised of a plurality of service guide fragments for use as entry points.

32. The method of claim 31, wherein the access fragment is associated with one of a plurality of broadcast channels, and the access rich media element indicates capabilities for the rich media engine to access and render rich media content associated with the associated broadcast channel, and
wherein the rich media content includes, in addition to an audio-video stream, at least some of animations, embedded media elements, scene orientation modes, and document object model (DOM) nodes.

33. The method of claim 31, wherein the preview data rich media element indicates a rich media Uniform Resource Identifier (URI) referencing the rich media clip, a media type of the rich media clip, alternative text to be displayed when the rich media clip is not available, and an alternative picture to be displayed when the rich media clip is not available or cannot be rendered by the mobile subscriber terminal.

34. A method of enhancing mobile broadcast services with rich media content comprising including an interactivity data fragment within service guide fragments to provide an entry point to an interactive media document,
wherein rich media content is embedded within the interactive media document to provide rich service level interaction, and
wherein the interactive media document comprises one of:
an initial scene in a media object set with an associated extension type and location,
an initial scene followed by a set of scene updates packaged in a scene command group; or
a file that includes a scene and scene updates.

35. The method of claim 34 further comprising:
including, as part of a terminal capability requirement element of an access fragment of the service guide fragments, an access rich media element that indicates capabilities for a rich media engine of a mobile subscriber terminal to access and render rich media content;
including, as part of a preview data fragment of the service guide fragments, a preview data rich media element that includes information for obtaining and previewing a rich media clip in a rich media format; and
providing a notification message to indicate updates to the service guide fragments, the notification message including rich media as a media type.
